(19) United States
(12) Patent Application Publication
(10) Pub. No.: US 2025/0212038 A1
(43) Pub. Date: Jun. 26, 2025

(54) COMMUNICATION METHOD AND COMMUNICATION APPARATUS

(71) Applicant: Beijing Xiaomi Mobile Software Co., Ltd., Beijing (CN)

(72) Inventor: Xiandong DONG, Beijing (CN)

(21) Appl. No.: 18/852,119

(22) PCT Filed: Apr. 8, 2022
(86) PCT No.: PCT/CN2022/085886

§ 371 Date: Sep. 27, 2024

(51) Int. Cl. H04W 24/10; H04W 16/28; H04W 84/12

(52) U.S. Cl. CPC H04W 24/10; H04W 16/28; H04W 84/12

(57) ABSTRACT

A communication method is performed by an access point device, and includes: determining a null data packet announcement (NDPA) frame, wherein the NDPA frame includes information about a transmitter and a receiver, wherein the transmitter is configured to transmit a sensing measurement frame and the receiver is configured to receive the sensing measurement frame; and transmitting the NDPA frame.

### CROSS REFERENCE TO RELATED APPLICATION

The present application is a U.S. National Stage of International Application No. PCT/CN2022/085886, filed on Apr. 8, 2022, the content of which is incorporated by reference herein in its entirety.

### TECHNICAL FIELD

The present disclosure relates to the field of wireless communications, and more specifically, to a communication method and a communication device.

### BACKGROUND

Wireless Local Area Network (WLAN) has the characteristics of flexibility, mobility and low cost. With the development of communication technology and the growth of user demand, the application research of WLAN is gradually deepening. For example, WLAN sensing is currently being studied, and its main application scenarios are: location discovery in dense environments (home environment and enterprise environment), proximity detection, and presence detection, etc.

### SUMMARY

Various embodiments of the present disclosure provide the following technical solutions:

According to an embodiment of the present disclosure, there is provided a communication method. The communication method can be performed by an access point device, and can include: determining a null data packet announcement NDPA frame, where the NDPA frame includes information about a transmitter and a receiver, where the transmitter is configured to transmit a sensing measurement frame and the receiver is configured to receive the sensing measurement frame; and transmitting the NDPA frame.

According to an embodiment of the present disclosure, there is provided a communication method. The communication method can be performed by a station device, and can include: receiving a null data packet announcement NDPA frame from an access point device, where the NDPA frame includes information about a transmitter and a receiver, where the transmitter is configured to transmit a first sensing measurement frame, and the receiver is configured to receive the first sensing measurement frame; and performing an operation for sensing measurement based on the NDPA frame.

According to an embodiment of the present disclosure, there is provided a communication device. The communication device can be applied to an access point device, and can include: a processing module configured to determine a null data packet announcement NDPA frame, where the NDPA frame includes information about a transmitter and a receiver, where the transmitter is configured to send a sensing measurement frame, and the receiver is configured to receive the sensing measurement frame; and a transceiver module configured to transmit the NDPA frame.

According to an embodiment of the present disclosure, there is provided a communication device. The communication device can be applied to a station device, and can include: a transceiver module configured to receive a null data packet announcement NDPA frame from an access point device, where the NDPA frame includes information about a transmitter and a receiver, where the transmitter is configured to transmit a first sensing measurement frame, and the receiver is configured to receive the first sensing measurement frame; and a processing module configured to control an execution of an operation for sensing measurement based on the NDPA frame.

According to an embodiment of the present disclosure, there is provided an electronic device. The electronic device includes a memory, a processor and a computer program stored on the memory and executable on the processor. The processor implements the method described above when executing the computer program.

According to an embodiment of the present disclosure, there is provided a computer-readable storage medium. A computer program is stored on the computer-readable storage medium. The method described above is implemented when the computer program is executed by a processor.

The technical solution provided by the embodiments of the present disclosure improves the mechanism of cooperative sensing measurement.

### BRIEF DESCRIPTION OF THE DRAWINGS

The above and other features of the embodiments of the present disclosure will become more apparent by describing in detail the embodiments of the present disclosure with reference to the accompanying drawings, wherein:

FIG. 1 is an example implementation illustrating WLAN sensing according to an embodiment.

FIG. 2 and FIG. 3 respectively illustrate two implementations of cooperative sensing measurement according to an embodiment.

FIG. 4 is a flow chart illustrating a communication method according to an embodiment.

FIG. 5 is a flow chart illustrating another communication method according to an embodiment.

FIG. 6 is a flow chart illustrating operations of a station device as a receiver according to an embodiment.

FIG. 7 is another flow chart illustrating operations of a station device as a receiver according to an embodiment.

FIG. 8 is a flow chart illustrating interactive communication according to an embodiment.

FIG. 9 is a block diagram illustrating a communication device according to an embodiment.

### DETAILED DESCRIPTION

The following description with reference to the accompanying drawings is provided to assist in a comprehensive understanding of the various embodiments of the present disclosure as defined by the attached claims and their equivalents. The various embodiments of the present disclosure include various specific details, but these specific details are considered to be exemplary only. In addition, for the sake of clarity and brevity, descriptions of well-known technologies, functions, and configurations may be omitted.

The terms and words used in the present disclosure are not limited to the written meanings, but are only used by the inventors to enable a clear and consistent understanding of the present disclosure. Therefore, for those skilled in the art, the descriptions of the various embodiments of the present disclosure are provided for the purpose of illustration only, not for the purpose of limitation.

It should be understood that the singular forms “a”, “an”, “said”, and “the” used herein may also include plural forms unless the context clearly indicates otherwise. It should be further understood that the wording “including” used in the present disclosure refers to the presence of the described features, integers, steps, operations, elements, and/or components, but does not exclude the presence or addition of one or more other features, integers, steps, operations, elements, components, and/or groups thereof.

It will be understood that although the terms “first”, “second”, etc. may be used herein to describe various elements, these elements should not be limited by these terms. These terms are only used to distinguish one element from another. Therefore, without departing from the teachings of the embodiments, the first element discussed below may be referred to as the second element.

It should be understood that when an element is referred to as being “connected” or “coupled” to another element, it may be directly connected or coupled to the other element, or there may be intermediate elements. In addition, the “connection” or “coupling” used herein may include wireless connection or wireless coupling. The term “and/or” or the expression “at least one of . . . ” used herein includes any and all combinations of one or more of the related listed items.

Unless otherwise defined, all terms used herein (including technical terms and scientific terms) have the same meaning as generally understood by those skilled in the art to which the present disclosure belongs.

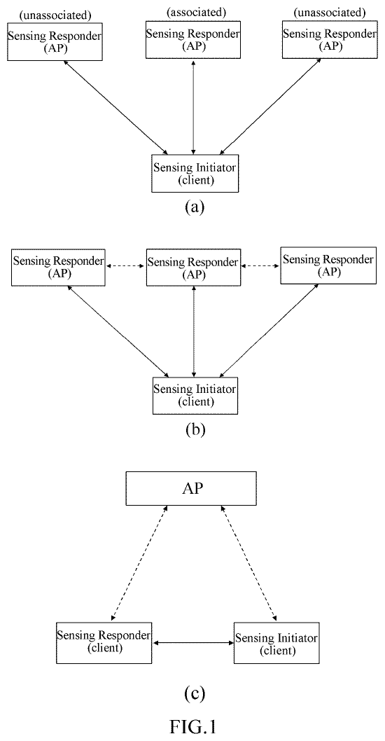

FIG. 1 is an example implementation illustrating WLAN sensing.

The process of WLAN sensing may be: an initiator initiates WLAN sensing (for example, initiates a WLAN sensing session), and there may be multiple responders to respond to it. The specific possible implementations may be shown in (a), (b) and (c) in FIG. 1.

Referring to (a) in FIG. 1, when a WLAN sensing initiator (e.g., a client) initiates WLAN sensing, multiple associated or unassociated WLAN sensing responders (e.g., three access points (APs)) may respond. Here, “associated” may refer to an associated connection for communication established between the initiator and the responder, and “unassociated” may refer to an associated connection for communication not established between the initiator and the responder.

For example, the client may include, but is not limited to: a cellular phone, a smart phone, a wearable device, a computer, a personal digital assistant (PDA), a personal communication system (PCS) device, a personal information manager (PIM), a personal navigation device (PND), a global positioning system, a multimedia device, an Internet of Things (IoT) device, etc.

AP may be a wireless switch for a wireless network or an access device for a wireless network. AP may include software applications and/or circuits to enable other types of nodes in a wireless network to communicate with the outside and inside of the wireless network through the AP. For example, AP may be a terminal device or a network device equipped with a Wi-Fi (Wireless Fidelity) chip.

(b) in FIG. 1 is similar to (a) in FIG. 1, but in (b) in FIG. 1, responders (APs) can communicate with each other.

Referring to (c) in FIG. 1, both the WLAN sensing initiator and the WLAN sensing responder can be clients, and the two can communicate by connecting to the same AP.

Although (a), (b) and (c) in FIG. 1 show that the client is the initiator and the AP is the responder, the present disclosure is not limited thereto. For example, in embodiments of the present disclosure, the AP can be the initiator and the client can be the responder. In addition, in embodiments of the present disclosure, the client can also be referred to as a “non-AP STA”, or “STA” for short. In addition, the number of initiators and responders is not limited to that shown in (a), (b) and (c) in FIG. 1.

As an illustrative embodiment, the process of WLAN sensing may include: WLAN sensing session setup, WLAN sensing measurement setup and WLAN sensing measurement termination. In a process of WLAN sensing session setup, an initiator (e.g., an AP) may initiate a WLAN sensing session, a responder (e.g., a STA) may respond thereto, and operating parameters associated with the sensing session may be determined and exchanged between devices. A WLAN sensing session setup may include one or more WLAN sensing measurement setups. That is, one or more WLAN sensing measurements may be set up between an initiator (e.g., an AP) and a responder (e.g., a STA). For example, each WLAN sensing measurement setup may be identified by a corresponding sensing measurement setup identifier (measurement setup ID). The WLAN sensing measurement corresponding to each sensing measurement setup identifier may include one or more WLAN sensing measurement events. For example, each WLAN sensing measurement event may be identified by a sensing measurement event identifier (measurement instance ID). A sensing measurement may be performed for each WLAN sensing measurement instance. In each WLAN sensing measurement instance, a sensing measurement frame may be sent by a transmitter, and a receiver may perform a sensing measurement using the received sensing measurement frame. As a non-limiting example only, the sensing measurement frame may be a Null Data Packet (NDP) frame. The transmitter of the sensing measurement frame may be an initiator or a responder, and correspondingly, the receiver of the sensing measurement frame may be a responder or an initiator. For example, in some embodiments, the transmitter for transmitting the sensing measurement frame may be an AP, and the receiver may be an STA. In this case, the receiver STA may report/feedback the sensing measurement result (for example, but not limited to, channel state information (CSI)) to the transmitter AP. In the WLAN sensing measurement termination, the device stops performing measurements and terminates the sensing session. It will be understood that the above-mentioned WLAN sensing process is only a descriptive embodiment, not a limitation of the present disclosure. For example, some of the processes may be omitted or split, or additional processes may be added, or some of the processes may be merged.

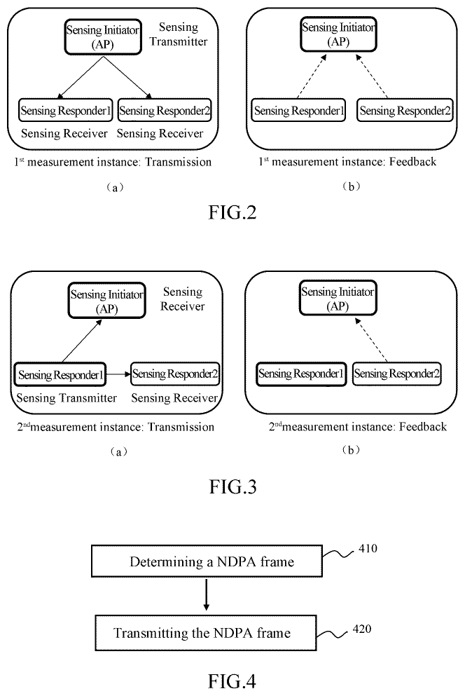

In the field of WLAN sensing, there are also collaborative sensing measurements. For example, FIG. 2 and FIG. 3 respectively show two implementations of collaborative sensing measurement.

In FIG. 2, a first measurement instance (also referred to as a first WLAN sensing measurement event) is shown. In (a) of the first measurement instance, the AP may initiate WLAN sensing as an initiator, and two responders respond. In addition, in (a) of the first measurement instance, the AP can act as a transmitter (i.e., transmit a sensing measurement frame), the two responders can act as receivers (i.e., receive the sensing measurement frame and perform sensing measurement), and available channel information can be transmitted from the initiator AP to responder 1 and from the initiator AP to responder 2. Correspondingly, in (b) of the first measurement instance, the two responders feed the sensing measurement result (e.g., CSI) back to the initiator.

In FIG. 3, a second measurement instance (also referred to as a second WLAN sensing measurement event) is shown. In (a) of the second measurement instance, the AP may initiate WLAN sensing as an initiator, and two responders respond. In addition, in (a) of the second measurement instance, responder 1 can act as a transmitter (i.e., transmit a sensing measurement frame), the initiator AP and responder 2 can act as receivers (i.e., receive the sensing measurement frame and perform sensing measurement), and available channel information can be transmitted from responder 1 to the initiator AP and from responder 1 to responder 2. Correspondingly, in (b) of the second measurement instance, responder 2 can feed the sensing measurement result (e.g., CSI) between responder 1 and itself back to the initiator AP.

In the above description, AP can set up sensing measurement with STA (responder) as an initiator. At the same time, AP can also allow STA to transmit a sensing measurement frame (e.g., a sensing NDP frame) as a transmitter (as shown in FIG. 3), and other STAs and AP can, as receivers, receive the NDP frame sent by the transmitter. However, in the current research, the mechanism for collaborative sensing measurement (as shown in FIG. 3) is still imperfect. For example, there are no specific provisions for the specific parameter and resource (e.g., resource unit (RU)) for transmitting/receiving the sensing measurement frame (e.g., NDP frame), which need to be enhanced.

In view of this, a communication method and a communication device are provided according to the concept of an embodiment of the present disclosure.

FIG. 4 is a flowchart showing a communication method according to an embodiment. The communication method shown in FIG. 4 can be applied to an access point device (which can be used interchangeably with “access point” and “AP” hereinafter).

Referring to FIG. 4, in step 410, a Null Data Packet Announcement (NDPA) frame may be determined; and in step 420, the NDPA frame may be transmitted

In an embodiment of the present disclosure, there may be many ways to determine the NDPA frame. For example, the NDPA frame may be generated or configured according to at least one of the following conditions: channel status, network condition, load condition, hardware capability of a transmitting/receiving device, service type, and related protocol provision; and the embodiments of the present disclosure are not specifically limited thereto. In an embodiment of the present disclosure, the NDPA frame may also be obtained from an external device, and the embodiments of the present disclosure are not specifically limited thereto.

According to an embodiment of the present disclosure, the NDPA frame transmitted by the AP may carry various parameters and resources related to WLAN sensing measurement.

A communication method, applied to an access point device, determines a Null Data Packet Announcement NDPA frame, where the NDPA frame may include information about a transmitter and a receiver, where the transmitter may be configured to send a sensing measurement frame, and the receiver may be configured to receive a sensing measurement frame. As in the embodiments described above, the sensing measurement frame may be an NDP frame for WLAN sensing. For example, the NDP frame may include working parameters required for performing WLAN sensing measurement, such as the number of spatial streams, the working bandwidth of the NDP frame, the long training field (LTF), the packet extension (PE), etc. However, the present disclosure is not limited thereto, and other frames carrying information for WLAN sensing measurement are also feasible. In addition, according to an embodiment of the present disclosure, the transmitter may be a STA, and the receiver may be an AP and other STAs. For example, the NDPA frame sent by the AP may carry information (e.g., working parameters, resources, etc.) about the STA as the transmitter, information about other STAs as the receivers, and/or information about the AP as the receiver. For example, this information may be identified by carrying different information fields in the NDPA frame. In the following, for the convenience of description, the STA as the transmitter may be referred to as a first station device, and the other STAs as the receivers may be referred to as a second station device (other station devices except the first station device).

According to an embodiment of the present disclosure, there is provided a communication method. The NDPA frame included in the communication method may include a first information field, where the first information field includes information of a first station device as a transmitter. For example, but not by way of limitation, the first information field may be referred to as a common info field.

For example, the first information field may include at least one of the following:
a sensing measurement setup identifier (measurement setup ID) that identifies the first station device as a transmitter to send a sensing measurement frame;
a sensing measurement event identifier (measurement instance ID);
information identifying a bandwidth used by the first station device to send the sensing measurement frame; and
identifying a number of spatial streams (NSS) used by the first station device to send the sensing measurement frame.

Although it is described in the above embodiment that the first information field may include a sensing measurement setup identifier and a sensing measurement instance identifier, this is only as an example and the present disclosure is not limited thereto. For example, when the first station device acts as a transmitter in all sensing measurement instances of a specific sensing measurement setup identifier, the sensing measurement instance identifier can be omitted. For another example, if there is only one sensing measurement setup identifier, the sensing measurement setup identifier can be omitted, and only the sensing measurement instance identifier corresponding to the sensing measurement setup identifier is included. For another example, if there is only one sensing measurement setup identifier and one sensing measurement instance identifier corresponding to it, both can be omitted. For another example, as described below, when the sensing measurement setup identifier and/or the sensing measurement instance identifier are determined in advance, each station can store them, and learn and store the roles of each station and AP in the corresponding sensing measurement process (as an initiator or a receiver). In this case, the sensing measurement setup identifier and/or the sensing measurement instance identifier can be omitted.

The first information field can include a sensing measurement setup identifier that identifies the first station device as a transmitter to send a sensing measurement frame, and/or a sensing measurement instance identifier that identifies the first station device as a transmitter to send a sensing measurement frame. That is, the first information field can identify the specific sensing measurement process in which the first station device participates as a transmitter. For example, such a sensing measurement setup identifier and/or a sensing measurement instance identifier may be determined in advance (e.g., determined before executing the communication method of FIG. 4). For example, it may be determined in the process of setting up sensing measurement between the access point device and the first station device. Specifically, in the process of the access point device initiating the sensing measurement setup with the first station device, the sensing measurement setup identifier and/or the sensing measurement instance identifier may be allocated (or determined) to (or for) the first station device through, for example, a sensing measurement setup message frame, and the sensing measurement setup identifier and the sensing measurement instance identifier may indicate that the first station device is the transmitter and the second station device (one or more other STAs and AP) is the receiver. In step 410, when determining the NDPA frame, the sensing measurement setup identifier and/or the sensing measurement instance identifier of the first station device as the transmitter may be included in the first information field, so as to identify that the first station device transmits a sensing measurement frame (e.g., an NDP frame) as the transmitter, that is, initiates responder to responder sensing measurement. Including the sensing measurement setup identifier and/or the corresponding sensing measurement instance identifier in the first information field helps the station device that receives the NDPA frame to accurately determine its own role in the sensing measurement process and respond quickly to the sensing measurement instance that will be performed later.

The first information field may include information about the bandwidth (BW) used by the first station device to transmit the sensing measurement frame (e.g., NDP frame). In other words, the first station device that receives the NDPA frame can learn the bandwidth it can use by parsing the first information field, and can transmit the NDP frame under this bandwidth. The access point device can determine (or specify) the BW for the first station device in the first information field to avoid communication conflicts.

The first information field may include information about the number of spatial streams (NSS) used by the first station device to transmit the sensing measurement frame (e.g., NDP frame). In other words, the first station device that receives the NDPA frame can learn the NSS it can use by parsing the first information field, and can use the NSS to transmit the NDP frame. The access point device can determine (or specify) the NSS for the first station device in the first information field to improve information transmission efficiency.

It will be understood that the information contained in the first information field (common information field) described in the above embodiment is only as an example, and the present disclosure is not limited thereto. For example, part of the information therein may be omitted or other more information may be added. For example, when the first station device can send an NDP frame at full bandwidth, BW may be omitted in the first information field.

According to an embodiment of the present disclosure, there is provided a communication method. The NDPA frame included in the communication method may include a second information field, where the second information field may include information of a second station device as a receiver. For example, but not by way of limitation, the first information field may be referred to as a station information (STA info) field.

For example, the second information field may include at least one of the following:
an identifier or address identifying the second station device;
identifying a resource used by the second station device to receive the sensing measurement frame;
identifying a number of spatial streams used by the second station device to receive the sensing measurement frame; and
identifying a received power of the second station device to receive the sensing measurement frame.

The second information field may include an identifier or address identifying the second station device. For example, the identifier or address of the second station device may be an AID, a UID, or a MAC (Media Access Control) address. Among them, AID can represent the identifier of the station that has established associated communication with the AP, and UID represents the identifier of the station that has not established associated communication with the AP. For example, there may be multiple station devices as receivers, so the station devices as receivers are clearly identified by including their respective identifiers or addresses.

The second information field may include a resource used by the second station device to receive the sensing measurement frame, e.g., a resource unit (RU). For example, the second information field may identify the resource unit (RU) used by the second station device to receive the sensing measurement frame (for example, NDP frame) through a subfield of the second information field (for example, a partial RU allocation subfield). The access point device may determine (or specify) resources for the second station device in the second information field, so that the second station device can use the identified resources to receive the NDP frame transmitted by the first station device. In this way, resources can be fully utilized and resource waste can be avoided.

The second information field may include the number of spatial streams (NSS) used by the second station device to receive the sensing measurement frame. That is, the number of spatial streams for the second station device to receive the NDP frame can be identified in the second information field. The access point device may determine (or specify) the NSS for the second station device in the second information field to improve the efficiency of information transmission.

The second information field may include the received power of the second station device to receive the sensing measurement frame. For example, the second information field may identify the power of the second station device receiving the NDP frame through a subfield of the second information field (for example, the receiver target power (Rx target power) subfield). Identifying the power of the second station device receiving the NDP frame in the second information field helps to ensure that the NDP frame can be effectively transmitted and received, thereby ensuring that the sensing measurement is effectively performed.

It will be understood that the information contained in the second information field (station information field) described in the above embodiment is only as an example, and the present disclosure is not limited thereto. For example, some of the information therein may be omitted or other more information may be added. For example, when the second station device can receive the NDP frame at full bandwidth, the bandwidth information may be omitted in the second information field. For another example, when the power requirement for the second station device to receive the NDP frame is low, the Rx target power may be omitted in the second information field. In addition, when there are multiple station devices as receivers, the NDPA frame may include multiple second information fields (station information fields), and various information of the corresponding station device as the receiver is identified in each second information field.

According to an embodiment of the present disclosure, there is provided a communication method. The NDPA frame included in the communication method may include a third information field, where the third information field may include information of the access point device as the receiver. For example, but not by way of limitation, the third information field may be referred to as a special station information (special STA info) field.

For example, the third information field may include at least one of the following:
an identifier or address identifying the access point device;
identifying a resource (e.g., RU) used by the access point device to receive the sensing measurement frame;
identifying a number of spatial streams (NSS) used by the access point device to receive the sensing measurement frame; and
identifying a receiving power (e.g., Rx target power) of the access point device to receive the sensing measurement frame.

The third information field may include an identifier or address that identifies the access point device. For example, the identifier or address of the access point device may be an assigned special AID or a MAC address of the access point device.

The RU, NSS, and Rx target power included in the third information field may be similar to the embodiment described above for the second information field. In order to avoid redundancy, repeated descriptions are omitted here.

It will be understood that the information contained in the third information field (special station information field) described in the above embodiment is only as an example, and the present disclosure is not limited thereto. For example, part of the information therein may be omitted or more information may be added.

According to an embodiment of the present disclosure, there is provided a communication method. The NDPA frame included in the communication method may include an identification bit for identifying that an access point device initiates a responder to responder sensing measurement, where the responder to responder sensing measurement may refer to: among the station devices that set up sensing measurement with the access point device, there is a first station device as a transmitter and a second station device as a receiver. That is, the NDPA frame has an identification bit, which identifies that the AP initiates the responder to responder sensing measurement. That is, among the STAs that set up sensing measurement with the AP, there is an STA as a transmitter and there is an STA as a receiver, and the AP is the receiver. However, this is only an example, and the present disclosure is not limited thereto. For example, such an identification bit may be omitted in the NDPA frame, and it may be implicitly determined that the AP initiates the responder to responder sensing measurement based on the NDPA frame including the first information field, the second information field, or the third information field.

Referring to FIG. 4 and the communication method described in the above embodiments, the format of the NDPA frame is improved so that it can be applied to collaborative sensing measurement, for example, responder to responder sensing measurement.

Although the information contained in the NDPA frame is described above with reference to the embodiments, these are only descriptive embodiments and not limitations of the present disclosure. Various deformations and modifications may be made to the embodiments.

The embodiments of the present disclosure may provide a communication method for collaborative sensing measurement. The communication method may be applied to an AP and may include: determining a first information field (for example, a common information field) of an NDPA frame; and transmitting the determined NDPA frame, where the first information field may include information of a first station device as a transmitter. For example, the first information field may include at least one of the following: a sensing measurement setup identifier that identifies the first station device as a transmitter to send a sensing measurement frame; a sensing measurement instance identifier; information identifying the bandwidth used by the first station device to send the sensing measurement frame; and a number of spatial streams used by the first station device to transmit the sensing measurement frame. For example, the sensing measurement setup identifier and the sensing measurement instance identifier may be determined in the process of setting up sensing measurement between the access point device and the first station device.

The embodiments of the present disclosure may also provide a communication method for collaborative sensing measurement. The communication method may be applied to an AP, and may include: determining a second information field (e.g., a station information field) of an NDPA frame; and transmitting the determined NDPA frame, where the second information field may include information of a second station device as a receiver. For example, the second information field may include at least one of the following: an identifier or address identifying a second station device; a resource used by the second station device to receive a sensing measurement frame; a number of spatial streams used by the second station device to receive a sensing measurement frame; a received power of the second station device to receive the sensing measurement frame.

The embodiments of the present disclosure may also provide a communication method for collaborative sensing measurement. The communication method may be applied to an AP, and may include: determining a third information field (a special station information field) of an NDPA frame; and transmitting the determined NDPA frame, where the third information field may include information of an access point device as a receiver. For example, the third information field may include at least one of the following: an identifier or address identifying an access point device; a resource used by the access point device to receive a sensing measurement frame; a number of spatial streams used by the access point device to receive a sensing measurement frame; a received power of the access point device to receive a sensing measurement frame.

The embodiments of the present disclosure may also provide a communication method for collaborative sensing measurement. The communication method may be applied to an AP, and may include: determining an identification bit of an NDPA frame for identifying that an access point device initiates a Responder to Responder sensing measurement; and transmitting the determined NDPA frame. The Responder to Responder sensing measurement may refer to: among the station devices that have set up sensing measurement with the access point device, there is a first station device as a transmitter and a second station device as a receiver.

FIG. 5 is a flowchart showing another communication method according to an embodiment. The communication method shown in FIG. 5 may be applied to a station device (hereinafter may be used interchangeably with “station” and “STA”). In addition, the communication method shown in FIG. 5 may be applied to a station device as a transmitter (may be referred to as a “first station device”), and may also be applied to a station device as a receiver (may be referred to as a “second station device”).

Referring to FIG. 5, in step 510, an NDPA frame is received from an access point device, where the NDPA frame may include information about a transmitter and a receiver, where the transmitter is configured to transmit a first sensing measurement frame, and the receiver is configured to receive the first sensing measurement frame. For example, but not by way of limitation, the first sensing measurement frame may be an NDP frame. For example, the transmitter may be a first station device, and the receiver may be a second station device (other station devices except the first station device) and an access point device.

According to an embodiment of the present disclosure, the NDPA frame may include a first information field, where the first information field may include information of the first station device as the transmitter.

According to an embodiment of the present disclosure, the first information field may include at least one of the following: a sensing measurement setup identifier identifying that the first station device sends the first sensing measurement frame as the transmitter; a sensing measurement instance identifier; information identifying the bandwidth used by the first station device to transmit the first sensing measurement frame; and a number of spatial streams used by the first station device to transmit the first sensing measurement frame.

According to an embodiment of the present disclosure, the sensing measurement setup identifier and the sensing measurement instance identifier may be determined in the process of setting up sensing measurement between the access point device and the first station device.

According to an embodiment of the present disclosure, the NDPA frame may include a second information field, where the second information field may include information of the second station device as the receiver.

According to an embodiment of the present disclosure, the second information field may include at least one of the following: an identifier or address identifying the second station device; a resource used by the second station device to receive the first sensing measurement frame; a number of spatial streams used by the second station device to receive the first sensing measurement frame; a received power of the second station device to receive the first sensing measurement frame.

According to an embodiment of the present disclosure, the NDPA frame may include a third information field, where the third information field may include information of the access point device as the receiver.

According to an embodiment of the present disclosure, the third information field may include at least one of the following: an identifier or address identifying the access point device; a resource used by the access point device to receive the sensing measurement frame; a number of spatial streams used by the access point device to receive the sensing measurement frame; a received power of the access point device to receive the sensing measurement frame.

According to an embodiment of the present disclosure, the NDPA frame may include an identification bit for identifying that the access point device initiates a Responder to Responder sensing measurement, where the Responder to Responder sensing measurement refers to that among the station devices that have set up sensing measurement with the access point device, there is a first station device as a transmitter and a second station device as a receiver.

The embodiment described above with reference to FIG. 4 and various other embodiments provided by the present disclosure may be applied here. For the sake of simplicity, repeated descriptions are omitted here.

In step 520, an operation for sensing measurement is performed based on the NDPA frame. Depending on whether the station device performing the communication method shown in FIG. 5 is a transmitter (first station device) or a receiver (second station device), different operations may be performed in step 520.

For example, in the case where the station device performing the communication method shown in FIG. 5 is a transmitter (first station device), the transmitter (first station device) may transmit a first sensing measurement frame (e.g., a first NDP frame) to the AP and the receiver (second station device) based on various working parameters and/or resources defined in various information fields of the NDPA frame.

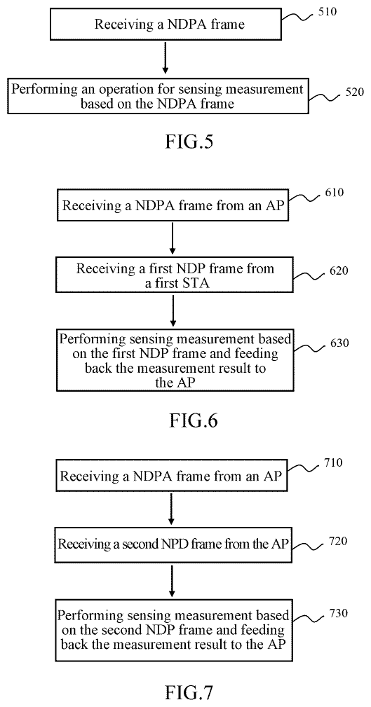

For example, in the case where the station device performing the communication method shown in FIG. 5 is a receiver (second station device), the receiver (second station device) may receive a first sensing measurement frame (e.g., a first NDP frame) from the first station device as the transmitter, as shown in step 620 of FIG. 6; and perform sensing measurement based on the first sensing measurement frame, and feed the result of the sensing measurement back to the access point device, as shown in step 630 of FIG. 6. In this case, the communication method of FIG. 5 performed by the receiver (second station device) can be transformed into FIG. 6, where step 610 can be similar to step 510 of FIG. 5, and for the sake of simplicity, repeated descriptions are omitted here.

For example, in the case where the station device performing the communication method shown in FIG. 5 is the receiver (second station device), the receiver (second station device) can receive a second sensing measurement frame (e.g., a second NDP frame) from the access point device, as shown in step 720 of FIG. 7; perform sensing measurement based on the second sensing measurement frame, and feed the result of the sensing measurement back to the access point device, as shown in step 730 of FIG. 7. In this case, the communication method of FIG. 5 performed by the receiver (second station device) can be transformed into FIG. 7, where step 710 can be similar to step 510 of FIG. 5, and for the sake of simplicity, repeated descriptions are omitted here.

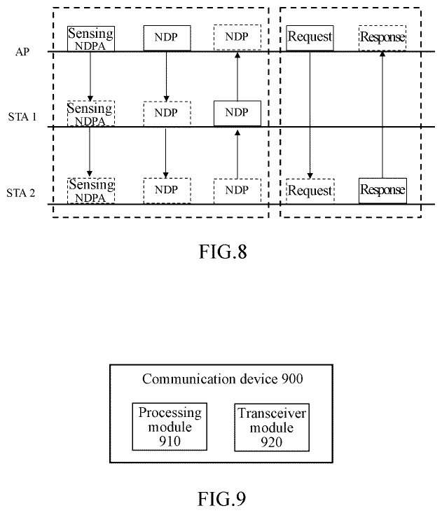

FIG. 8 is a flowchart showing interactive communication according to an embodiment. In FIG. 8, STA 1 can be a transmitter, and AP and STA 2 can be receivers.

Referring to FIG. 8, the AP may send an NDPA frame (i.e., a sensing NDPA frame) to STA 1 and STA 2, and the NDPA frame may carry information about the transmitter and one or more receivers, which may be similar to the embodiment described above with reference to FIG. 4 and various other embodiments provided in the present disclosure. For the sake of simplicity, repeated descriptions are omitted here.

Next, a collaborative sensing measurement similar to FIG. 2 may be performed. For example, the AP may send an NDP frame to STA 1 and STA 2, and the NDP frame may be used for WLAN sensing. That is, in this case, the AP may act as a transmitter and send a sensing measurement frame to STA 1 and STA 2. However, this is merely an example, the present disclosure is not limited thereto, and the operation may be omitted. In addition, although not shown, STA 1 and STA 2 may perform sensing measurements based on the NDP frame received from the AP, and feed their respective sensing measurement results back to the AP.

In addition, a collaborative sensing measurement similar to FIG. 3 may also be performed. Specifically, STA 1 as a transmitter may send a sensing measurement frame (NDP frame) to the receiver STA 2 and the AP. The AP may perform sensing measurement based on the received NDP frame, and obtain the sensing measurement result between the AP and STA1 (e.g., channel state information between the AP and STA1). STA 2 may perform sensing measurement based on the received NDP frame, and obtain the sensing measurement result between STA1 and STA2 (e.g., channel state information between STA1 and STA2). Next, the AP may send, for example, a request frame to STA 2 to request the sensing measurement result of STA 2; STA 2 that receives the request frame sends, for example, a response frame to the AP to feed back its sensing measurement result to the AP. However, the present disclosure is not limited thereto. For example, STA 2 may feed the sensing measurement result back to the AP immediately after performing the sensing measurement without the AP sending a request to STA 2.

In FIG. 8, STA 2 (responder) can receive the NDPA frame and NDP frame sent by AP, and after receiving the NDP frame sent by AP, after SIFS (Short interframe space), it can receive the NDP frame sent by STA 1, and then send the measurement report frame to AP (initiator). However, the present disclosure is not limited to this. For example, some operations can be omitted, or additional operations can be added.

FIG. 9 is a block diagram illustrating a communication device according to an embodiment. The communication device 900 of FIG. 9 may include a processing module 910 and a transceiver module 920. In one embodiment of the present disclosure, the communication device 900 shown in FIG. 9 may be applied to an access point device. In another embodiment of the present disclosure, the communication device 900 shown in FIG. 9 may be applied to a station device.

In the case where the communication device 900 shown in FIG. 9 can be applied to an access point device, the processing module 910 can be configured to determine a null data packet announcement (NDPA) frame, where the NDPA frame can include information about a transmitter and a receiver, where the transmitter is configured to send a sensing measurement frame, and the receiver is configured to receive the sensing measurement frame. The transceiver module 920 can be configured to send the NDPA frame. More specifically, the communication device 900 shown in FIG. 9 can perform the communication method described with reference to FIG. 4 and the operations performed by the AP in FIG. 8, and repeated descriptions are omitted here to avoid redundancy.

In the case where the communication device 900 shown in FIG. 9 can be applied to a station device, the transceiver module 920 can be configured to receive a null data packet announcement (NDPA) frame from an access point device, where the NDPA frame can include information about a transmitter and a receiver, where the transmitter is configured to send a first sensing measurement frame, and the receiver is configured to receive the first sensing measurement frame. The processing module 910 can be configured to control the execution of an operation for sensing measurement based on the NDPA frame. More specifically, the communication device 900 shown in FIG. 9 can perform the communication method described with reference to FIGS. 5 to 7 and the operations performed by STA 1 or STA 2 in FIG. 8. To avoid redundancy, repeated descriptions are omitted here.

It will be understood that the communication device 900 shown in FIG. 9 is only an example, and the embodiments of the present disclosure are not limited thereto. For example, the communication device 900 may also include other modules, such as a memory module, etc. In addition, the modules in the communication device 900 may be combined into a more complex module, or may be divided into more separate modules.

The communication method and the communication device according to the embodiments of the present disclosure improve the mechanism of cooperative sensing measurement, for example, improve the format of the NDPA frame so that it can be applicable to the sensing measurement scenario of responder to responder.

Based on the same principle as the method provided in the embodiments of the present disclosure, the embodiments of the present disclosure also provide an electronic device, which includes a processor and a memory; where the memory stores machine-readable instructions (also referred to as “computer programs”); the processor is configured to execute the machine-readable instructions to implement the method described with reference to FIGS. 4 to 8.

The embodiments of the present disclosure also provide a computer-readable storage medium on which a computer program is stored. When the computer program is executed by a processor, the method described with reference to FIGS. 4 to 8 is implemented.

In an embodiment, the processor may be a computer program for implementing or executing various logic blocks, modules, and circuits described in conjunction with the contents of the present disclosure, such as a CPU (Central Processing Unit), a general-purpose processor, a DSP (Digital Signal Processor), an ASIC (Application Specific Integrated Circuit), an FPGA (Field Programmable Gate Array), or other programmable logic devices, transistor logic devices, hardware components, or any combination thereof. The processor may also be a combination that implements a computing function, such as a combination of one or more microprocessors, a combination of a DSP and a microprocessor, etc.

In an embodiment, the memory may be, for example, ROM (Read Only Memory), RAM (Random Access Memory), EEPROM (Electrically Erasable Programmable Read Only Memory), CD-ROM (Compact Disc Read Only Memory) or other optical disk storage, optical disk storage (including compact disc, laser disc, optical disc, digital versatile disc, Blu-ray disc, etc.), magnetic disk storage medium or other magnetic storage device, or any other medium that can be configured to carry or store program code in the form of instructions or data structures and can be accessed by a computer, but is not limited thereto.

It should be understood that although the steps in the flowchart of the accompanying drawings are displayed in sequence as indicated by the arrows, these steps are not necessarily executed in the order indicated by the arrows. Unless otherwise specified herein, the execution of these steps is not strictly limited in order and they can be executed in other orders. In addition, at least a part of the steps in the flowchart of the accompanying drawings may include multiple sub-steps or multiple stages, and these sub-steps or stages are not necessarily performed at the same time, but may be performed at different timings, and their execution order is not necessarily sequential, but may be performed in turn or alternately with other steps or at least a part of the sub-steps or stages of other steps.

Although the present disclosure has been shown and described with reference to certain embodiments of the present disclosure, those skilled in the art will understand that various changes may be made in form and detail without departing from the scope of the present disclosure. Therefore, the scope of the present disclosure should not be limited to the embodiments, but should be defined by the appended claims and their equivalents.

1. A communication method, performed by an access point device, comprising:
determining a null data packet announcement (NDPA) frame, wherein the NDPA frame comprises information about a transmitter and a receiver, wherein the transmitter is configured to transmit a sensing measurement frame and the receiver is configured to receive the sensing measurement frame; and
transmitting the NDPA frame.

2. The communication method according to claim 1, wherein the NDPA frame comprises a first information field, wherein the first information field comprises information of a first station device as the transmitter.

3. The communication method according to claim 2, wherein the first information field comprises at least one of:
a sensing measurement setup identifier identifying the first station device as the transmitter to transmit the sensing measurement frame;
a sensing measurement instance identifier;
information identifying a bandwidth used by the first station device to transmit the sensing measurement frame; and
information identifying a number of spatial streams used by the first station device to transmit the sensing measurement frame.

4. The communication method according to claim 3, wherein the sensing measurement setup identifier and the sensing measurement instance identifier are determined in a process of setting up sensing measurement between the access point device and the first station device.

5. The communication method according to claim 1, wherein the NDPA frame comprises a second information field, wherein the second information field comprises information of a second station device as the receiver.

6. The communication method according to claim 5, wherein the second information field comprises at least one of:
an identifier or address identifying the second station device;
information identifying a resource used by the second station device to receive the sensing measurement frame;
information identifying a number of spatial streams used by the second station device to receive the sensing measurement frame; and
information identifying a received power of the second station device to receive the sensing measurement frame.

7. The communication method according to claim 1, wherein the NDPA frame comprises a third information field, wherein the third information field comprises information of the access point device as the receiver.

8. The communication method according to claim 7, wherein the third information field comprises at least one of:
an identifier or address identifying the access point device;
information identifying a resource used by the access point device to receive the sensing measurement frame;
information identifying a number of spatial streams used by the access point device to receive the sensing measurement frame; and
information identifying a received power of the access point device to receive the sensing measurement frame.

9. The communication method according to claim 1, wherein the NDPA frame comprises an identification bit for identifying that the access point device initiates a Responder to Responder sensing measurement,
wherein the Responder to Responder sensing measurement refers to that, among station devices that have set up sensing measurement with the access point device, there is a first station device as the transmitter and a second station device as the receiver.

10. A communication method, performed by a station device, comprising:
receiving a null data packet announcement (NDPA) frame from an access point device, wherein the NDPA frame comprises information about a transmitter and a receiver, wherein the transmitter is configured to transmit a first sensing measurement frame, and the receiver is configured to receive the first sensing measurement frame; and
performing an operation for sensing measurement based on the NDPA frame.

11. The communication method according to claim 10, wherein the NDPA frame comprises a first information field, wherein the first information field comprises information of a first station device as the transmitter.

12. The communication method according to claim 11, wherein the first information field comprises at least one of:
a sensing measurement setup identifier identifying the first station device as the transmitter to transmit the first sensing measurement frame;
a sensing measurement instance identifier;
information identifying a bandwidth used by the first station device to transmit the first sensing measurement frame; and
information identifying a number of spatial streams used by the first station device to transmit the first sensing measurement frame.

13. The communication method according to claim 12, wherein the sensing measurement setup identifier and the sensing measurement instance identifier are determined in a process of setting up sensing measurement between the access point device and the first station device.

14. The communication method according to claim 10, wherein the NDPA frame comprises a second information field, wherein the second information field comprises information of a second station device as the receiver.

15. (canceled)

16. The communication method according to claim 14, wherein in the case where the station device is the second station device as the receiver, the communication method further comprises:
receiving, by the second station device, a second sensing measurement frame from the access point device; and
performing sensing measurement based on the second sensing measurement frame, and feeding back a sensing measurement result to the access point device.

17. The communication method according to claim 14, wherein in the case where the station device is the second station device as the receiver, the communication method further comprises:
receiving, by the second station device, the first sensing measurement frame from the first station device as the transmitter; and
performing sensing measurement based on the first sensing measurement frame, and feeding back a sensing measurement result to the access point device.

18. The communication method according to claim 10, wherein the NDPA frame comprises a third information field, wherein the third information field comprises information of the access point device as the receiver.

19. (canceled)

20. The communication method according to claim 10, wherein the NDPA frame comprises an identification bit for identifying that the access point device initiates a Responder to Responder sensing measurement,
wherein the Responder to Responder sensing measurement refers to that, among station devices that have set up sensing measurement with the access point device, there is a first station device as the transmitter and a second station device as the receiver.

21. (canceled)

22. (canceled)

23. An electronic device, comprising:
a processor; and
a memory storing a computer program executable by the processor, wherein the processor is configured to:
determine a null data packet announcement (NDPA) frame, wherein the NDPA frame comprises information about a transmitter and a receiver, wherein the transmitter is configured to transmit a sensing measurement frame and the receiver is configured to receive the sensing measurement frame; and
transmit the NDPA frame.

24. (canceled)

25. An electronic device, comprising:
a processor; and
a memory storing a computer program executable by the processor,
wherein the processor is configured to perform the method of claim 10.
